(19) United States
(12) Patent Application Publication
(10) Pub. No.: US 2015/0012834 A1
(43) Pub. Date: Jan. 8, 2015

(54) PROVIDING USER ACTIVITY SUGGESTIONS

(71) Applicant: Nokia Corporation, Espoo (FI)

(72) Inventors: Giovanni Cannata, London (GB); Jennifer Lee, London (GB); Jason Marchant, Surrey (GB); Laura Cavanagh, London (GB)

(21) Appl. No.: 13/934,856

(22) Filed: Jul. 3, 2013

(51) Int. Cl. G06F 3/0484

(52) U.S. Cl. CPC G06F 3/0484
USPC 715/738

(57) ABSTRACT

Apparatus, a method and a computer program is provided. The apparatus includes: at least one processor; and at least one memory storing computer program code configured, working with the at least one processor, to cause at least the following to be performed: enabling a user to set one or more user activity settings; and providing at least one user activity suggestion based, at least in part, upon the one or more user activity settings.

### TECHNOLOGICAL FIELD

Embodiments of the present invention relate to providing user activity suggestions. In particular, they relate to providing user activity suggestions based, at least in part, on one or more user activity settings.

### BACKGROUND

On some occasions, a person may find that he has some spare time before his next meeting or appointment. It may not be clear how that time could be used in an effective, healthy and/or pleasurable way.

### BRIEF SUMMARY

According to various, but not necessarily all, embodiments of the invention there is provided apparatus, comprising: at least one processor; and at least one memory storing computer program code configured, working with the at least one processor, to cause at least the following to be performed: enabling a user to set one or more user activity settings; and providing at least one user activity suggestion based, at least in part, upon the one or more user activity settings.

According to various, but not necessarily all, embodiments of the invention there is provided a method, comprising: enabling a user to set one or more user activity settings; and providing at least one user activity suggestion based, at least in part, upon the one or more user activity settings.

According to various, but not necessarily all, embodiments of the invention there is provided a non-transitory computer readable medium storing computer program code configured, working with at least one processor, to cause at least the following to be performed: enabling a user to set one or more user activity settings; and providing at least one user activity suggestion based, at least in part, upon the one or more user activity settings.

### BRIEF DESCRIPTION

For a better understanding of various examples that are useful for understanding the brief description, reference will now be made by way of example only to the accompanying drawings in which:

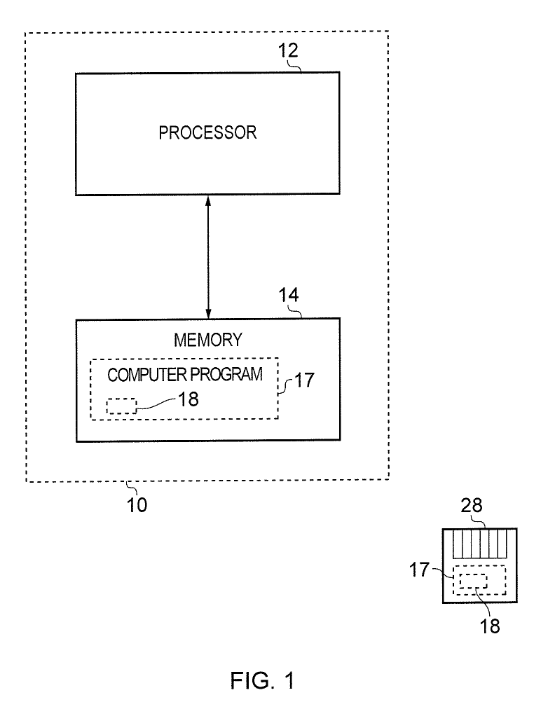

FIG. 1 illustrates a first apparatus in the form of a chip or chipset;

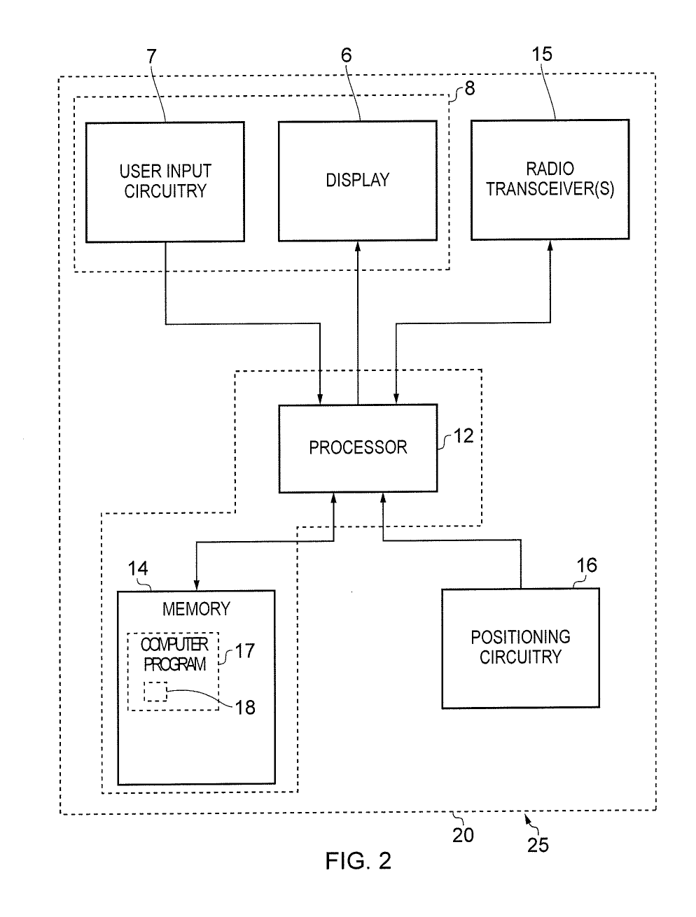

FIG. 2 illustrates a second apparatus in the form of a portable electronic device;

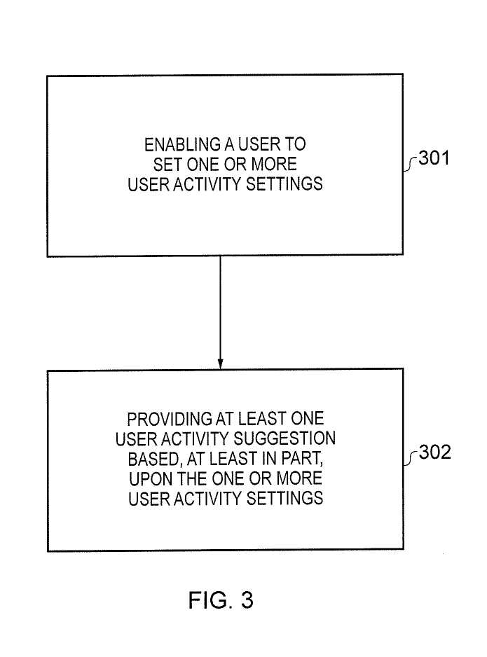

FIG. 3 illustrates a flow chart of a method;

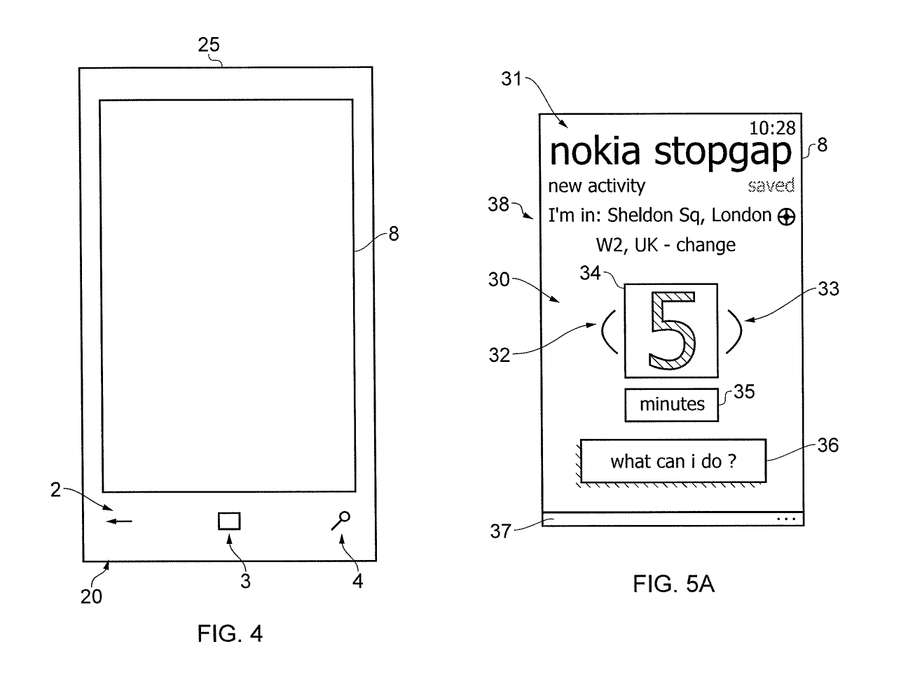

FIG. 4 illustrates a front face of a portable electronic device;

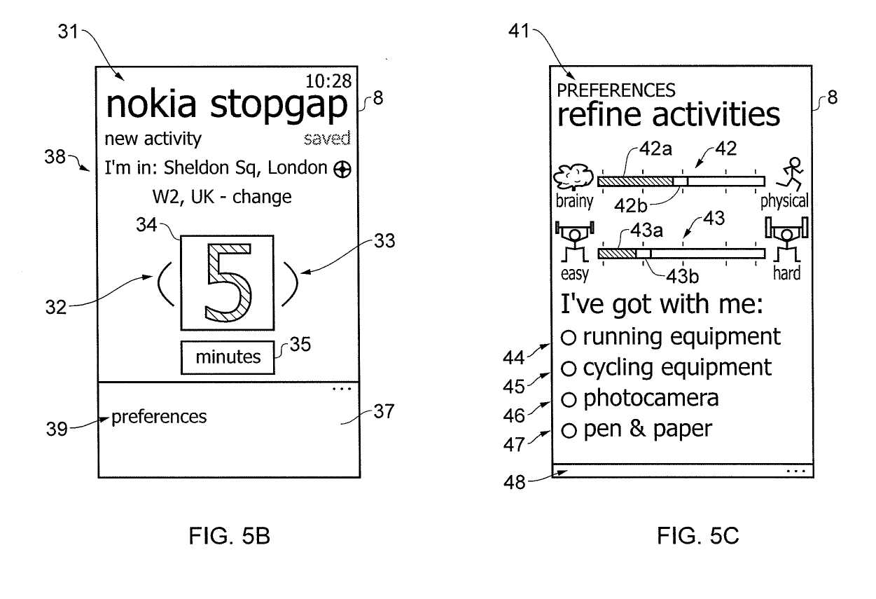

FIG. 5A illustrates a home screen of a user activity application;

FIG. 5B illustrates the home screen of the user activity application displaying an option to access the preferences screen;

FIG. 5C illustrates the preferences screen of the user activity application;

FIG. 5D illustrates a first example of a user activity suggestion screen of the user activity application;

FIG. 5E illustrates the first example of the user activity suggestion screen of the user activity application displaying an additional options menu; and

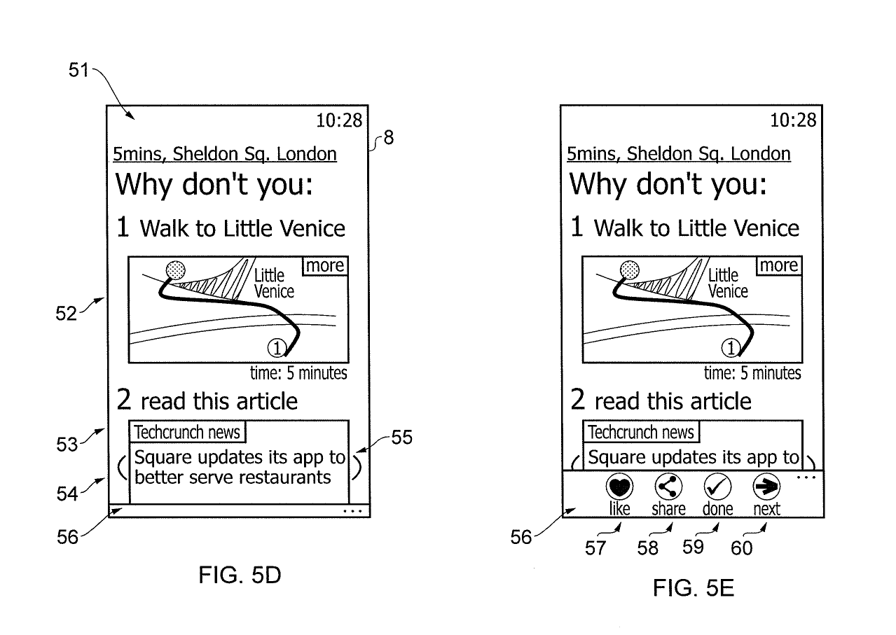

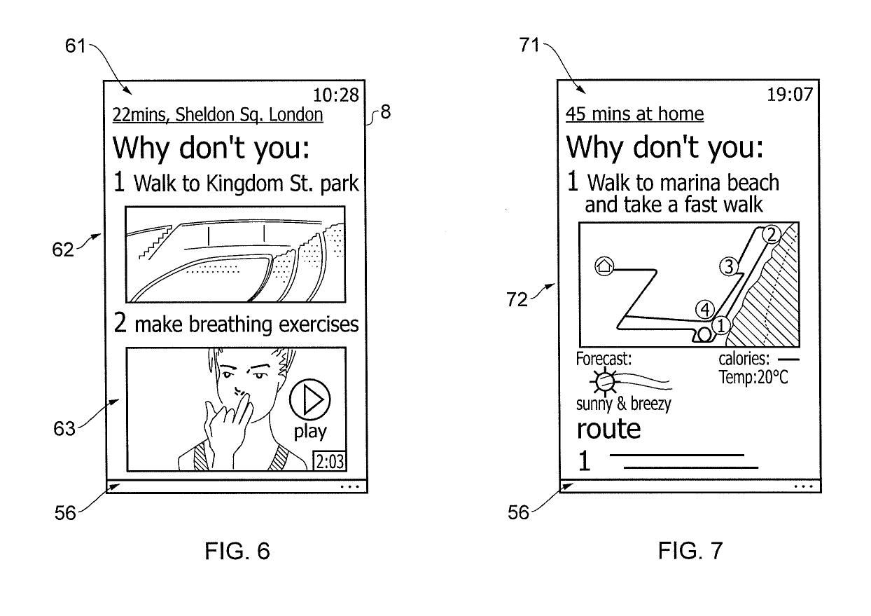

FIGS. 6 and 7 illustrate possible second and third examples of the user activity suggestion screen of the user activity application.

### DETAILED DESCRIPTION

Embodiments of the invention relate to providing user activity suggestions based, at least in part, on one or more user activity settings. The user may define the user activity settings, for example, in accordance with a particular context, the user's preferences and/or the user's interests. The user activity suggestions that are made may enable the user to use his time in an effective, healthy and/or pleasurable way. This is explained in further detail below.

The figures illustrate apparatus 10/20, comprising: at least one processor 12; and at least one memory 14 storing computer program code 18 configured, working with the at least one processor 12, to cause at least the following to be performed: enabling a user to set one or more user activity settings 30, 42-47; and providing at least one user activity suggestion 52, 53, 62, 63, 72 based, at least in part, upon the one or more user activity settings 30, 42-47.

FIG. 1 illustrates an apparatus 10 that may be a chip or a chipset. The apparatus 10 comprises one or more processors 12 (in the form of processing circuitry) and at least one memory 14 (in the form of memory circuitry). A single processor 12 and a single memory 14 are shown in FIG. 1 merely for illustrative purposes.

The processor 12 is configured to read from and write to the memory 14. The processor 12 may comprise an output interface via which data and/or commands are output by the processor 12 and an input interface via which data and/or commands are input to the processor 12.

The memory 14 stores computer program instructions/code 18 that control the operation of the apparatus 10 when loaded into the processor 12. The computer program code 18 provides the logic and routines that enables the apparatus 10 to perform the method illustrated in FIG. 3. The processor 12, by reading the memory 14, is able to load and execute the computer program code 18.

Although the memory 14 is illustrated as a single component it may be implemented as one or more separate components some or all of which may be integrated/removable and/or may provide permanent/semi-permanent/dynamic/cached storage.

The computer program instructions 18 may arrive at the apparatus 10 via any suitable delivery mechanism 28. The delivery mechanism 28 may be, for example, a non-transitory computer-readable storage medium such as a compact disc read-only memory (CD-ROM) or digital versatile disc (DVD). The delivery mechanism 28 may be a signal configured to reliably transfer the computer program code 18. The apparatus 10 may cause the propagation or transmission of the computer program code 18 as a computer data signal.

FIG. 2 illustrates a further apparatus 20 in the form of an electronic device. The electronic device 20 may be a portable electronic device such as, for example, a mobile telephone, a portable music player, a hand held games console or a tablet computer.

The electronic device/apparatus 20 illustrated in FIG. 2 includes: a display 6, user input circuitry 7, at least one radio transceiver 15, positioning circuitry 16, an external housing 25 and the apparatus 10 illustrated in FIG. 1. In this example the external housing 25 houses the display 6, the user input circuitry 7, the radio transceiver(s) 15, the positioning circuitry 16, the processor 12 and the memory 14.

The display 6 is configured to display information under the control of the processor 12. The display 6 may be any type of display. It may, for example, be a liquid crystal display (LCD), an organic light emitting diode (OLED) display or a quantum dot display.

The user input circuitry 7 is configured to receive inputs from a user. In response to receiving an input from a user, the user input circuitry 7 provides a signal to the processor 12 that depends upon the input that has been provided by the user.

In some embodiments of the invention, at least part of the user input circuitry 7 is integrated with the display 6, in the form of a touch sensitive display 8. The touch sensitive display 8 may be any type of touch sensitive display. It might function, for example, using capacitive, resistive, infrared, dispersive signal and/or acoustic pulse technology.

The radio transceiver(s) 15 may be configured to transmit and receive radio frequency signals. The radio transceiver(s) 20 might be compatible with one or more radio protocols, such as cellular or IEEE (Institute of Electrical and Electronic Engineers) protocols.

The positioning circuitry 16 is configured to determine the position of the apparatus 20. In some implementations, the positioning circuitry 16 may be satellite positioning circuitry. Such satellite positioning circuitry might operate in accordance with the Global Positioning System (GPS), the GLONASS system, the Galileo system and/or the Beidou system.

The elements 6, 7, 12, 14, 15 and 16 are operationally coupled and any number or combination of intervening elements can exist between them (including no intervening elements).

FIG. 3 is a flow chart of a method according to embodiments of the invention. At block 301 in FIG. 3, the processor 12 enables a user to set one or more user activity settings. The processor 12 may do this by, for example, controlling the display 6 to display one or more user activity settings. At block 302 in FIG. 3, the processor 12 provides at least one user activity suggestion based, at least in part, upon those user activity settings.

A more detailed description of the method illustrated in FIG. 3 is given below in relation to FIGS. 4 to 7.

FIG. 4 illustrates an example of the apparatus 20 described above in relation to FIG. 2.

The front face of the apparatus 20 is shown in FIG. 4. In this particular example, the apparatus 20 comprises a touch sensitive display 8. The user input circuitry 7 includes keys 2, 3, 4 in this example, via which the user may provide input. The keys 2, 3, 4 could, for instance, be mechanical (moving) keys or capacitive keys. In this example, the leftmost key 2 is a back key, the central key is a home key 3 and the rightmost key 4 is a searching key.

The user may provide input via the keys 2, 3, 4 and/or the display 8 to cause the processor 12 to run a user activity application which, in this particular example, is entitled “Nokia Stopgap”. The Nokia Stopgap application might, for example, be an application that is downloadable from an online store. The application provides a user with useful suggestions for activities that he could perform if he has some spare time.

FIG. 5A illustrates the home screen 31 of the Nokia Stopgap application. The home screen 31 is the screen which is displayed initially when the Nokia Stopgap application is opened/initiated by the user.

The home screen 31 includes an indication 38 of the user's location, a user activity setting 30, an activity suggestion graphical item 36 and an options graphical item 37.

In order to display the indication of the user's location, when the Nokia Stopgap application is initiated, the processor 12 may cause the positioning circuitry 16 to obtain the location of the apparatus 20, obtain the location from the positioning circuitry 16 and then display the indication 38 of the location on the display 8.

The user activity setting 30 displayed on the home screen 31 enables the user to set a time period that is available to him for performing one or more activities. In the illustrated example, the available time period has been set to 5 minutes.

A first portion 34 of the user activity setting 30 displays a numerical value (in this case, 5) and a second portion 35 displays a unit associated with the numerical value (in this example, minutes). Third and fourth portions 32, 33 of the user activity setting 30 are arrows which enable the user to adjust the numerical value in the first portion 34 upwards and downwards. Selection of the arrow 32 decreases the numerical value, while selection of the arrow 33 increases the numerical value.

The activity suggestion graphical item 36 is user selectable. If the user provides touch input at the activity suggestion graphical item 36, the processor 12 responds to the input by providing one or more user activity suggestions. This will be described in more detail below.

The options graphical item 37 is also user selectable. If the user provides touch input at the options graphical item 37, the processor 12 responds by changing the appearance of the options graphical item 37 as illustrated in FIG. 5B. In this example, the options graphical item 37 expands upwardly to reveal a user selectable preferences item 39.

If the user provides touch input at the preferences item 39, the processor 12 responds by replacing the home screen 31 with a preferences screen 41. The preferences screen 41 includes a number of user activity settings 42-47 and is illustrated in FIG. 5C.

A first user activity setting 42 on the preferences screen 41 enables the user to set a preference for one type of activity, rather than another, in a single setting. In the illustrated example, the first user activity setting 42 comprises a slider 42a with a handle 42b. One end of the slider 42a is associated with intellectual activities (“brainy” activities) and the other end of the slider 42a is associated with physical activities. If the user wishes to express a preference for intellectual activities rather than physical activities, he provides input to move the handle 42b of the slider 42a towards the end associated with intellectual activities and the processor 12 responds by moving the handle 42b accordingly. Alternatively, if the user wishes to express a preference for physical activities rather than intellectual activities, he provides input to move the handle 42b of the slider 42a towards the end associated with physical activities and the processor 12 responds by moving the handle 42b accordingly.

In the illustrated example, the handle 42b is situated in the center of the slider 42a, which means that the user has expressed a preference for neither intellectual activities nor physical activities.

A second user activity setting 43 on the preferences screen 41 enables the user to set a difficulty level for activities. In the illustrated example, the second user activity setting 43 comprises a slider 43a with a handle 43b. One end of the slider 43a is associated with easy activities and the other end of the slider 42a is associated with hard activities. If the user wishes to express a preference for easy activities rather than hard activities, he provides input to move the handle 43b of the slider 43a towards the end associated with easy activities and the processor 12 responds by moving the handle 43b accordingly. Alternatively, if the user wishes to express a preference for hard activities rather than easy activities, he provides input to move the handle 43b of the slider 42a towards the end associated with hard activities and the processor 12 responds by moving the handle 43b accordingly.

In the illustrated example, the user has set the difficulty of the activities reasonably low, by placing the handle 43b closer to the easy end of the slider 43a than the hard end.

A number of user activity settings 44-47 on the preferences screen 41 enable the user to set which equipment he has available to him at the current time. Of these, a third user activity setting 44 on the preferences screen 41 enables the user to set whether or not he has running equipment available to him. The user may indicate that he has running equipment available to him by providing touch input at the setting 44.

A fourth user activity setting 45 on the preferences screen 41 enables the user to set whether or not he has cycling equipment available to him. The user may indicate that he has cycling equipment available to him by providing touch input at the setting 45.

A fifth user activity setting 46 on the preferences screen 41 enables the user to set whether or not he has a camera available to him. The user may indicate that he has a camera available to him by providing touch input at the setting 46.

A sixth user activity setting 47 on the preferences screen 41 enables the user to set whether or not he has a pen and paper available to him. The user may indicate that he has a pen and paper available to him by providing touch input at the setting 47.

Other user activity settings may be available that are not illustrated in the figures. For example, some user activity settings may enable the user to set an interest, such as an interest in sport, music or art, for instance.

Once the user has set the user activity settings 42-47 on the preferences screen 41 in accordance with his wishes, he actuates the back key 2 of the user input circuitry 7. The processor 12 responds to actuation of the back key 2 by controlling the display 8 to revert back to displaying the previous screen that was displayed, which in this case is the home screen 31 of the Nokia Stopgap application (as illustrated in FIG. 5A).

The user then provides touch input at the activity suggestion graphical item 36, which causes the processor 12 to respond by providing at least one user activity suggestion based, at least in part, upon the user activity settings 30, 41-47 as previously set/adjusted by the user. The user activity suggestion(s) may also be based, at least in part, upon the location of the user/apparatus 20 as determined by the positioning circuitry 16.

The processor 12 controls the display 8 to display the user activity suggestion(s) to the user. An example of a user activity suggestion screen 51 is illustrated in FIG. 5D.

The user activity suggestion screen 51 illustrated in FIG. 5D mentions a first suggested activity in a first portion 52 of the display 8 and mentions a second suggested activity in a second portion 53 of the display 8. In this particular example, the first and second activity suggestions 52, 53 are alternatives, each of which is estimated (by the processor 12) to take the user 5 minutes or less to perform (5 minutes being the available time period set in the time setting 30 in this instance). In other examples, multiple activities may be suggested where the total time that is estimated by the processor 12 to be required to perform all of the activities, one after another, is the same or less than the available time set in the time setting 41.

In the event that different suggested activities are to be performed in different geographical areas, the processor 12 may, for example, estimate the travelling time that is required to travel between those geographical areas in order to determine whether they can all be performed in the available time set in the time setting 41. In this regard, a user activity setting may be present in the preferences screen 41 that enables a user to set one or more available modes of transport (for example, car, taxi, public transport) which is used to make the estimation of the travelling time.

In FIG. 5D, the first suggested activity in the first portion 52 of the display 8 is a suggested walk from the determined location of the user/apparatus 20. The second suggested activity in the second portion 53 of the display 8 is a suggested article to read. The user may provide input at the arrow graphical items 54, 55, which causes the processor 12 to respond by scrolling through different suggested articles.

In some implementations of the invention, an analysis of prior user activity may be carried out and the user activity suggestions may be based, at least in part, upon the analysis. The analysis may be carried out by the processor 12 or, alternatively, the analysis may be carried out by a remote server. The data that is analyzed might be stored in the local memory 14 or at a remote location.

For instance, the walk mentioned in the first portion 52 may be suggested because it is determined from the analysis that the user has been on similar walks in other locations in the past. The article in the second portion 53 may be suggested because it is determined from the analysis (for example, of the user's browsing history, Internet searching history, prior email exchanges and/or previous social networking posts) that the user has read (or may have read) similar articles or articles from the same (or similar) websites in the past.

In some implementations, if the user provides touch input at the first portion 52, the processor 12 responds by controlling the display 8 to display a map. The map may include directions to a location at which the activity may be performed (which, in this example, might be the location at which the walk begins). Alternatively or additionally, the processor 12 may control the display 8 to display a map indicating a path for the walk.

If the user provides touch input at the second portion 53, the processor 12 may respond by opening an application that can be used to access the article (for example, an Internet browser) and by controlling the radio transceiver 15 to retrieve the article.

The user activity suggestion screen 51 illustrated in FIG. 5D includes an options graphical item 56. If input is provided at the options graphical item 56, the processor 12 responds by changing the appearance of the options graphical item 56 as illustrated in FIG. 5E. In this example, the options graphical item 56 expands upwardly to reveal an options menu including a plurality of user selectable options 57-60.

A first user selectable option 57 enables the user to “like” the suggested activity or activities. If the user provides input to select the first user selectable option 57, the processor 12 may respond by causing a message to be sent to one or more social networking platforms (for example, using the radio transceiver 15) indicating that the user likes the suggested activity or activities.

The processor 12 may be configured to provide future user activity suggestions based on (at least in part) activities that the user has previously “liked”. For example, the processor 12 may suggest activities that are the same as (or similar to) previously liked activities.

A second user selectable option 58 enables the user to “share” the suggested activity or activities. If the user provides input to select the second user selectable option 58, the processor 12 may respond by causing a message to be sent to one or more social networking platforms (for example, using the radio transceiver 15) that causes the suggested activity or activities to be shared with connections/friends of the user on that/those social networking platform(s).

A third user selectable option 59 enables the user to indicate that he has done the suggested activity or activities. If the user provides input to select the third user selectable option 59, the processor 12 may respond by controlling the display 8 to display the home screen 31 of the application.

A fourth user selectable option 60 enables the user to indicate that he wishes to see the next suggested activity or activities. If the user provides input to select the fourth user selectable option 60, the processor 12 may respond by controlling the display 8 to display one or more different suggested activities.

In some implementations, if the user skips a predetermined number of suggested activities (by selecting the fourth selectable option 60 a number of times), the processor 12 responds by controlling the display 8 to display the preferences screen 41.

FIG. 6 illustrates another example 61 of a user activity suggestion screen. The activity suggestion screen 61 illustrated in FIG. 6 mentions a first suggested activity in a first portion 62 of the display 8 and mentions a second suggested activity in a second portion 63 of the display 8.

FIG. 7 illustrates a further example 71 of user activity suggestion screen. The activity suggestion screen 71 illustrated in FIG. 7 mentions a single suggested activity on the display 8. In this example, the activity is a physical activity, and information which is relevant to that activity is displayed on the display 8. In this instance, the weather conditions and the potential number of calories which could be burnt by the user are displayed.

References to ‘non-transitory computer-readable storage medium’, a ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

Although embodiments of the present invention have been described in the preceding paragraphs with reference to various examples, it should be appreciated that modifications to the examples given can be made without departing from the scope of the invention as claimed. For example, Nokia Stopgap might not be a separate application from an operating system. Instead, the features of Nokia Stopgap could be integrated into the operating system.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

I/We claim:

1. Apparatus, comprising:
at least one processor; and
at least one memory storing computer program code configured, working with the at least one processor, to cause at least the following to be performed:
enabling a user to set one or more user activity settings; and
providing at least one user activity suggestion based, at least in part, upon the one or more user activity settings.

2. The apparatus as claimed in claim 1, wherein at least one of the one or more user activity settings enables the user to set a time period available to the user for performing one or more activities.

3. The apparatus as claimed in claim 1, wherein the at least one user activity suggestion is based, at least in part, on a location of the user.

4. The apparatus as claimed in claim 1, wherein the at least one user activity suggestion is based, at least in part, on equipment available to the user.

5. The apparatus as claimed in claim 4, wherein at least one of the one or more user activity settings enables the user to set the equipment available to the user.

6. The apparatus as claimed in claim 1, wherein at least one of the one or more user activity settings enables the user to set one or more user preferences.

7. The apparatus as claimed in claim 1, wherein at least one of the one or more user activity settings enables the user to set one or more user interests.

8. The apparatus as claimed in claim 1, further comprising: analyzing prior user activity; and wherein the at least one user activity suggestion is based, at least in part, upon the analysis.

9. A method, comprising:
enabling a user to set one or more user activity settings; and
providing at least one user activity suggestion based, at least in part, upon the one or more user activity settings.

10. The method as claimed in claim 9, wherein at least one of the one or more user activity settings enables the user to set a time period available to the user for performing one or more activities.

11. The method as claimed in claim 9, wherein the at least one user activity suggestion is based, at least in part, on a location of the user.

12. The method as claimed in claim 9, wherein the at least one user activity suggestion is based, at least in part, on equipment available to the user.

13. The method as claimed in claim 12, wherein at least one of the one or more user activity settings enables the user to set the equipment available to the user.

14. The method as claimed in claim 9, wherein at least one of the one or more user activity settings enables the user to set one or more user preferences.

15. The method as claimed in claim 9, wherein at least one of the one or more user activity settings enables the user to set one or more user interests.

16. The method as claimed in claim 9, further comprising: analyzing prior user activity; and wherein the at least one user activity suggestion is based, at least in part, upon the analysis.

17. A non-transitory computer readable medium storing computer program code configured, working with at least one processor, to cause at least the following to be performed:
enabling a user to set one or more user activity settings; and
providing at least one user activity suggestion based, at least in part, upon the one or more user activity settings.

18. The non-transitory computer readable medium as claimed in claim 17, wherein at least one of the one or more user activity settings enables the user to set a time period available to the user for performing one or more activities.

19. The non-transitory computer readable medium as claimed in claim 17, wherein the at least one user activity suggestion is based, at least in part, on a location of the user.

20. The non-transitory computer readable medium as claimed in claim 17, wherein the at least one user activity suggestion is based, at least in part, on equipment available to the user.
